(19) United States
(12) Patent Application Publication
(10) Pub. No.: US 2026/0038291 A1
(43) Pub. Date: Feb. 5, 2026

(54) USING VISUAL LANGUAGE MODELS TO DETERMINE LOCATIONS OF IMAGE ELEMENTS WITHIN GRAPHICAL IMAGES

(71) Applicant: DeepMind Technologies Limited, London (GB)

(72) Inventors: Massimo Nicosia, Zurich (CH); Francesco Piccinno, Zurich (CH)

(21) Appl. No.: 18/794,786

(22) Filed: Aug. 5, 2024

(51) Int. Cl. G06V 30/19; G06F 40/186; G06V 30/24; G06V 30/30

(52) U.S. Cl. CPC G06V 30/19147; G06F 40/186; G06V 30/24; G06V 30/30

(57) ABSTRACT

A method performed by one or more computers and for training a visual language model to identify locations of image elements within an image. The method comprises: generating a plurality of training data items, each training data item including (i) an image rendered according to a corresponding set of instructions, (ii) a natural language query for identifying at least one image element of the image, and (iii) a target location for the at least one image element, the target location being determined from the set of instructions. The method further comprises, for each of the training data items, processing the corresponding image and natural language query using a visual language model to generate a corresponding model output comprising a predicted location of an image element identified from the natural language query.

### BACKGROUND

This specification relates to processing inputs using neural networks to generate output sequences.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification describes a system implemented as computer programs on one or more computers in one or more locations for training a visual language model to identify locations of image elements within a graphical image, such as a chart, diagram, or technical drawing. As a result of the training, the ability of the visual language model to process and reason about graphical images and text relating to graphical images can be improved, e.g., such that the performance of visual language model on other tasks, such as recognising characters (e.g., text) in a graphical image, or otherwise extracting information about the graphical image, is improved.

In a first aspect, there is provided a method performed by one or more computers and for training a visual language model to identify locations of image elements within an image. The method comprises generating a plurality of training data items, each training data item including (i) a training input comprising a graphical image rendered according to a corresponding set of instructions, and a natural language query for identifying at least one image element of the graphical image, and (ii) a target location for the at least one image element. The target location is determined from the set of instructions. The method further comprises, for each of the training data items, processing the corresponding graphical image and natural language query of the training input using the visual language model to generate a corresponding model output comprising a predicted location of an image element identified from the natural language query. The method also includes adjusting parameters of the visual language model to optimize, for each of the training data items, an objective function that depends on a comparison between the predicted location of the model output corresponding to the training data item and the target location of the training data item.

As used herein, a graphical image is an (e.g., two-dimensional) image composed of a plurality of image elements that provides a visual representation (“visualization”) of data, processes, events, or objects. By way of example, a graphical image can include one or more of: a chart, such as a bar chart or line graph that provides a visual representation of a particular data set, e.g., as part of a technical report; a diagram, such as a CAD drawing, e.g., for use in manufacturing a product, or an electronic circuit diagram, e.g., an integrated circuit layout; and a flow-diagram of a process, e.g., for assembling or otherwise configuring a product, or synthesizing a chemical product. In some case, the graphical image can include text, e.g., for labelling, captioning or otherwise annotating the graphical image, or image elements in the graphical image, e.g., to provide axis labels or tick values, a legend or key, a title and so on. In some cases, the graphical image can additionally or alternatively comprise one or more raster images (e.g., photographic images, bitmaps, or a image elements decorated using an image-based texture). As one example, the graphical image can comprise a flow chart (e.g., representing a manufacturing process) that includes one or more photographic image of how the product or components should look (e.g., at each stage of manufacture) alongside text (e.g., instructions for the manufacture). Thus, in some implementations, the visual language model can be trained to identify the locations (e.g., bounding boxes) of image elements that are photographic image elements.

As particular examples, the image elements can comprise one or more of: lines, curves, shapes, polygons, or other geometric forms, vertices, points, vectors, text, characters, symbols, a rasterized image (e.g., a bitmap image), and so on. In some cases, the image elements can be represented as vector elements prior to rendering (e.g., rasterizing) the graphical image to obtain a corresponding representation of the image elements as pixel values, e.g., in a bitmap image. Instructions for rendering a graphical image can, for example, comprise instructions in a computer programming language, e.g., instructions comprising calls to a computer graphics or plotting library, and/or or a mark-up language (such as HTML, LaTeX, XML, etc.).

As used herein, a visual language model (VLM) is a multimodal language model for processing inputs comprising image and text data modalities. That is, the VLM can be configured to receive a model input comprising text data and image data, and process the model input to generate a corresponding model output. In general, the model output can comprise data of any appropriate modality or modalities, e.g., text data, image data, a combination of text and image data, and so on. As one example, the text data can comprise instructions for a computer, e.g., computer code or instructions in one or more programming languages. In some examples, the VLM is configured to process the image as a sequence of image tokens, e.g., together with text tokens generated from the natural language query. In general, the rendered image processed by the VLM comprises pixel data encoding color and/or intensity values for pixels of the image.

In some implementations, generating the plurality of training data items comprises, for each of the training data items: processing the set of instructions corresponding to the graphical image of the training data item to generate a data structure comprising one or more sets of coordinates for the at least one image element of the training data item (e.g., coordinates corresponding to each of the vertices of the image element); and determining the target location of the at least one image element using the data structure.

For example, determining the target location of the at least one image element using the data structure can comprise converting the one or more pairs of coordinates to corresponding pixel locations within the graphical image. Thus, in some implementations, the data structure can comprise a vector representation of the image element(s) from which a rasterized graphical image can be obtained.

In some implementations, the natural language query can include a natural language description of the at least one image element, the description being generated using (i) the set of instructions corresponding to the graphical image, or (ii) the data structure, or (iii) both.

In some implementations, generating the natural language description of the at least one image element can comprise updating a query template by replacing one or more placeholder elements of the query template with corresponding properties of the at least one image element. As one example, the query template can comprise natural language instructions for generating the natural language query.

By way of example, the one or more properties of the at least one image element can comprise one or more of: a name of the image element; a type of the image element; a label in the graphical image corresponding to the image element; a shape of the image element; a style, color, or texture of the image element; an orientation of the image element; and text associated with the image element.

In some implementations, the natural language query can be generated by processing the updated query template using a language model, such as a language model neural network. For example, the language model neural network may be a large language model (LLM) neural network. The language model can be the same as the visual language model, or it may be a different language model, e.g., a language model that has been fine-tuned for generating natural language queries for the particular task of training the visual language model.

In some implementations, each set of instructions is generated by sampling one or more values of a corresponding image property from a distribution of values for the image property. For example, the distribution of values for the image property may be a discrete distribution, such that the sampled one or more values are each one of a predefined set of values, such as styles or fonts for text, or the distribution of values can be a continuous distribution, e.g., a uniform or non-uniform distribution for a location within a pre-defined range or region of the graphical image. In some cases, the sampled one or more values of a corresponding image property can comprise text, e.g., text sampled from a language model, such as an LLM or the VLM. For example, the text can be generated by a language model in response to one or more text prompts being provided to the language model.

For example, the one or more image properties can comprise one or more of: an arrangement of image elements in the image; a color or style for the image or for an image element of the image; a size of the image or of an image element of the image; text to display in the image; text to label an image element of the image; and values for quantities represented in a chart of the image.

In some implementations, each predicted location can comprise locations of vertices of a polygon that encloses all or part of the corresponding image element. For example, the locations of the vertices can define a bounding box for the image element, e.g., a rectangular or square bounding box.

In some examples, each predicted location can comprise one or more pixel locations within the graphical image for the corresponding image element.

In some implementations, each graphical image comprises text (e.g., alphanumeric characters). For example, the at least one image element can comprise text, e.g., a label, caption, or reference numeral for another image element in the graphical image.

In some instances, each graphical image comprises a respective one or more of: a diagram, a chart, a data table, and a map.

In some implementations, the method further comprises, after training the visual language model: receiving an image (e.g., a graphical image) and a natural language query for identifying at least one image element of the image; and processing the image and the natural language query using the (trained) visual language model to predict a location of the at least one image element of the image identified from the natural language query.

In some implementations, the method further comprises, after training the visual language model, using the visual language model to perform a character or word recognition task on an image, e.g., a graphical image. For example, the visual language model can process a model input comprising one or more images to generate a corresponding model output identifying one or more characters contained in the one or more images. The one or more “characters” may, for example, comprise alphanumeric characters, logograms (e.g., Chinese characters and/or characters from other logographic writing systems), symbols, syllabograms, ideograms, ideographs, pictographs, graphemes, graphical symbols or objects, and the like.

In another aspect, there is provided a method performed by one or more computers and for using a visual language model to identify locations of image elements within an image, e.g., a graphical image. The method comprises receiving an image and a natural language query for identifying at least one image element of the image. The method further comprises processing the image and the natural language query using a visual language model, e.g., trained using the method of the above first aspect, to predict a location of the at least one image element of the image identified from the natural language query.

In some implementations, the method comprises annotating the image at a location derived from the predicted location of the at least one image element.

In some implementations, the method comprises generating link data associating the predicted location of the at least one image element with a corresponding substring of the natural language query or a text output of the VLM. For example, the link data can be used to align words, sentences or paragraphs in text relating to the image (e.g., a summary or description of the image) generated by the VLM with corresponding image elements of the image. For example, the link data can be used to create a user interface in which a user can navigate to a relevant figure or image after selecting a substring of the text, or vice versa.

In some implementations, the method further comprises performing an image processing operation on the image based on at least the predicted location of the at least one image element. The image processing operation can, for example, comprise one or more of: highlighting the at least one image element (e.g., by changing a color of the image element, drawing a border around a region comprising the image element, and so on), cropping the image (e.g., to exclude a region of the image that comprises, or alternatively does not comprise, the image element), scaling a region of the image comprising the at least one image element, and removing the at least one image element from the image. For example, after the image processing task has been performed on the image, the updated image can be processed by an image processing machine learning model, e.g., by the VLM or another VLM, that performs a machine learning task on the updated image. The performance of the image processing machine learning model in performing the machine learning task can be improved as a result of performing the image processing task on the image. For example, by cropping the image or enlarging part(s) of the image, the machine learning model can be guided towards, or focus on, the more relevant part(s) of the image.

In some implementations, the method further comprises using the predicted location of the at least one image element to determine a veracity (factuality) of a statement (e.g., a natural language statement) about the image. For example, the image could be a chart indicating the respective sizes of the populations of each of a plurality of cities, such as London, Berlin, Zurich, Toronto and New York, and the natural language query may identify that one of the cities is more populous than another of the cities, e.g., “London has a greater population than New York”. The VLM may then determine the locations of the image elements in the chart (e.g., if the chart is a pie chart, the segments of the pie chart) that depict the sizes of the respective populations of London and New York, and based on the locations, determine whether the statement is true or false. For example, the locations of the image elements can be provided as inputs to the VLM (or another VLM) to assist the VLM in reasoning about the natural language query.

As another example, the method can comprise selecting a statement from a plurality of statements about the image based at least in part on the predicted location of the at least one image element. The method may then comprise providing the selected statement as an output, e.g., responsive to a natural language query provided by a user. In some cases, the statements can be generated by a language model (e.g., the VLM) as potential responses to the natural language query. For example, the VLM may generate a plurality of candidate responses to the query, process each of the candidate responses together with the image to identify whether the response are consistent with the image. For example, continuing the example above, when processing the statement “London has a greater population than New York” the VLM may identify the respective locations of the bars corresponding to New York and London in the bar chart, and then based on the locations, determine whether the statement is true or false. In cases, where no corresponding image element can be identified by the VLM, the VLM may, for example, determine the statement is false, or that more information is needed. Thus, the trained VLM can generate more appropriate responses to user queries about e.g., graphical images.

As a general example, the trained VLM can be used to process an image, captured by a camera, that comprises a graphical image, e.g., a photograph or video frame comprising a graphical image, e.g., on a display surface, such as a whiteboard, blackboard, or paper document. For example, the VLM may be used to process graphical images drawn on a whiteboard or paper, e.g., during a design or planning meeting, to perform any of a number of tasks, such as summarising, answering questions, or otherwise providing feedback regarding the drawn graphical image.

Using techniques described in this specification, the ability of a visual language model to perform tasks relating to graphical (e.g., “data heavy”) images, such as charts, diagrams or maps can be improved. In particular, training a visual language model to determine locations of image elements in graphical images, can improve the performance of visual language models that have been pre-trained or fine-tuned on datasets that predominantly or exclusively comprise natural images, e.g., photographs.

For example, the visual language model can learn to associate parts of text descriptions of graphical images with corresponding image elements in the graphical images, which can improve the ability of the visual language model to reason about the graphical images. Thus, the trained visual language model can, for example, be used to perform tasks on complex documents that comprise text and graphical images, such as scientific articles, CAD drawings and so forth. The visual language model can also assist users in understanding such documents, e.g., by allowing image elements to be highlighted or annotated in response to user requests. The visual language model can additionally or alternatively be used, for example, to determine the whether text describing a graphical image is factually correct, e.g., based on whether image elements identified from the text can be found in the graphical image.

The details of one or more embodiments of the subject matter of this specification are set forth in the accompanying drawings and the description below.

Other features, aspects, and advantages of the subject matter will become apparent from the description, the drawings, and the claims.

### BRIEF DESCRIPTION OF THE DRAWINGS

FIG. 1 shows an example training system for training a visual language model.

FIG. 2 shows an example training data generator.

FIG. 3 shows an example query generator.

FIG. 4 is an example visual language model.

FIG. 5 is a flow diagram of an example process for training a visual language model.

FIG. 6 is a flow diagram of an example process for using a visual language model to identify locations of image elements within an image.

Like reference numbers and designations in the various drawings indicate like elements.

### DETAILED DESCRIPTION

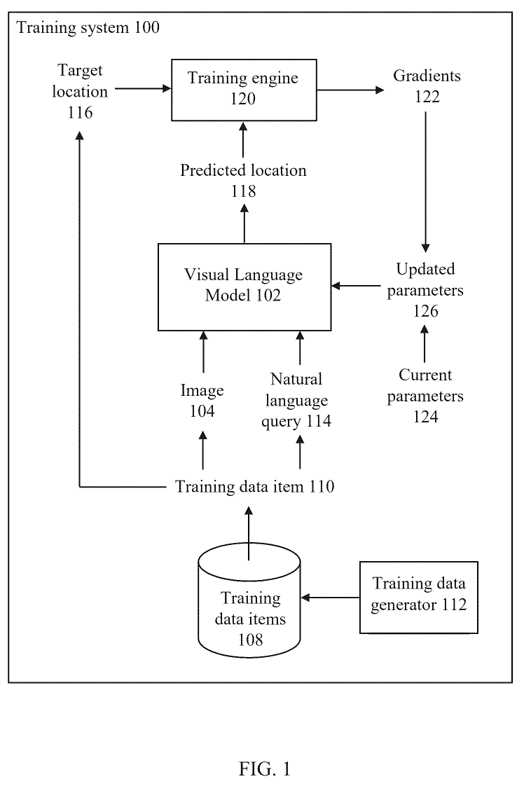

FIG. 1 shows an example training system 100 for training a visual language model (VLM) 102, e.g., a visual language model neural network, to identify locations of image elements within a graphical image 104. The training system 100 is an example of a system implemented as computer programs on one or more computers in one or more locations in which the systems, components, and techniques described below are implemented.

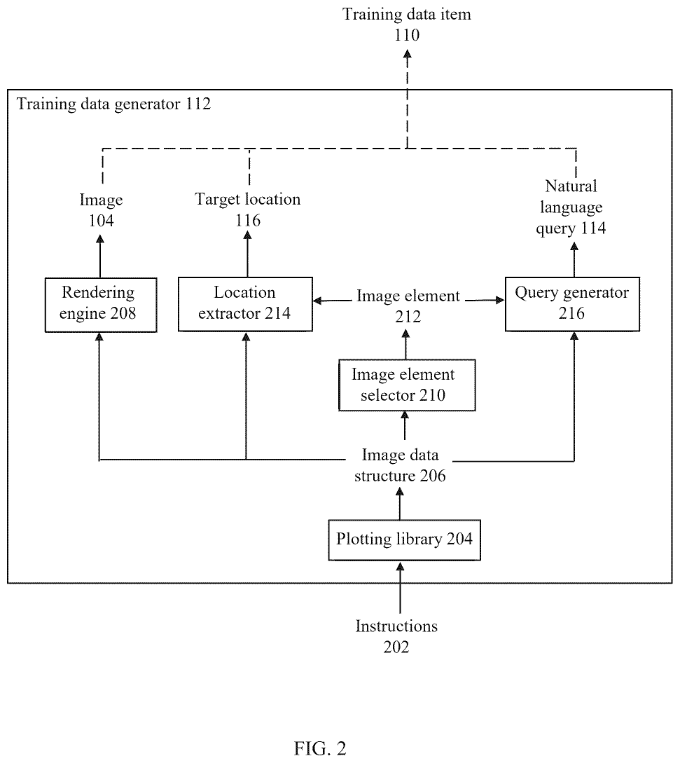

The training system 100 trains the VLM 102, in this case a VLM neural network, using a plurality of training data items 108, which may for example, be stored in a database populated using a training data generator 112, such as the training data generator 112 described below in connection with FIG. 2.

The VLM 102 can process a model input comprising text and one or more images to generate a corresponding model output, which can comprise text and/or one or more images. In some cases, the model output can comprise data of a different modality, e.g., audio data, instead of or as well as the text and/or image data. For example, the VLM 102 can process input sequences comprising tokens that each represent natural language text or (a part of) an image or video to generate output tokens that each represent natural language or (a part of) an image or video. For example, the VLM may encode an image, e.g., as features for each of a set of tokens or patches that tile the image, or as a sequence of visual tokens selected from a vocabulary of visual tokens, or as a representation of distinct objects in the visual input. Such visual tokens may, but need not be, interleaved with text tokens processed by the model.

The VLM 102 can be pre-trained to perform one or more machine learning tasks and then “fine-tuned” using the training system 100. For example, the VLM 102 may be configured to describe an image using natural language, e.g., to perform an image captioning task. As another example, the VLM 102 may be configured to perform an image question answering task, e.g., by processing input tokens representing an image and text tokens representing a query about the image or a request to modify the image, and generate output tokens representing an answer to the query or representing a version of the image that has been modified in accordance with the request. The VLM 102 may generate output tokens representing an image that is generated in response to input tokens providing a visual and/or audio and/or textual description of a desired image. In some implementations, the VLM 102 may also process input data of other modalities, such as audio data. Some example visual language models with which the techniques described herein may be used include: Flamingo (Alayrac et al., arXiv:2204.14198); ALIGN (Jia et al., arXiv:2102.05918); PaLI (Chen et al., arXiv:2209.06794); and PaLI-X (Chen et al., arXiv:2305.18565).

Each training data item 110 comprises a graphical image 104 rendered according to a corresponding set of instructions, e.g., a chart or graph, a diagram, or an infographic. For example, the graphical image can comprise one or more of: a flow chart; a bar chart; a histogram; a pie chart; a line graph; a scatter plot; a box plot, a Gantt chart; a Venn diagram; an area chart; a box and whisker chart; a bubble chart; a radar chart; a flow chart; and so on. As another example, the graphical image 104 may comprise one or more of: a floorplan; a geographic map, e.g., annotated with route information; a circuit diagram; an integrated circuit layout; a blueprint or technical drawing, e.g., a diagram for a scientific article, a patent-style drawing, or CAD drawing; assembly instructions for a product, e.g., an item of furniture; and a chemical structure. The graphical image 104 may additionally comprise text, e.g., as annotations or labels for elements of the image, e.g., a label of an axis of a chart, or one or more tables, i.e., data presented in tabular form.

In some implementations, the set of instructions used to render the graphical image 104 can comprise instructions in a computer programming language that when executed by a computer cause the computer to render the image 104. The instructions can, for example, use one or more graphics or plotting libraries to compose and/or render the graphical image, e.g., a vector graphics library.

Each training data item 110 further comprises a natural language query 114 that identifies at least one image element of the image. As one example, when the image 104 is a chart, the natural language query 114 may comprise an instruction relating to one of the bars of the chart, e.g., “draw a bounding box around the bar located at the far left of the chart”. As another example, the image element can be a table or part of a table, e.g., a row, or a column, or an entry of a table. The natural language query 114 may then, for example, comprise an instruction such as “highlight the entry with the largest value” or “output the coordinates of a bounding box for the second row of the table”.

Each training data item 110 also comprises a target location 116 for the at least one image element. In general, the target location is determined from the set of instructions used to render the image 104, e.g., as described below in connection with FIG. 2. The target location 116 can, for example, define a polygon, such as a rectangle or “bounding box” that encloses the image element.

The VLM 102 processes the image 104 and natural language query 114 to generate a predicted location 118 for the at least one image element identified in the natural language query 114. The predicted location 118 may be output in any form that is appropriate to the task of identifying the location of the image element within the image 104. For example, the predicted location 118 may specify a polygon, such as a rectangular bounding box, that encloses the image element, e.g., by specifying respective pixel coordinates for the vertices of the polygon. In general, the predicted location 118 may comprise text in a natural or computer language that defines a location of the image element. The computer language may be any formal language used to communicate with a computer, e.g., a mark-up language, or a command or configuration language, or a data exchange language such as JSON, or a programming language. In some cases, the VLM 102 may be configured to generate the output text according to a predetermined format, syntax or schema, e.g., by performing constrained decoding. One example of constraining the output of the VLM 102 in this way is described in Koo et al., “Automata-based constraints for language model decoding” arXiv:2407.08103 (2024).

The training system 100 further comprises a training engine 120 that receives as input the predicted location 118 and the target location 116, and generates as a corresponding output, gradients 122, with respect to the current (trainable) parameters 124 of the VLM 102, of an objective function that depends on a comparison between the predicted location of the model output and the corresponding target location of the image element. The objective function provides a metric for the performance of the VLM 102 in identifying the location of the image element within the image 104. In general, the objective function can be any objective function that is appropriate to this task. For example, the objective (loss) function may be a least-squares objective function, a cross-entropy objective function, and so on. As one example, the objective function can depend on a sum of (e.g., the squares of) the distances between each coordinate pair in the predicted location 118 and the corresponding coordinate pair in the target location 116. The gradients 122 with respect to the trainable parameters of the VLM 102 can be determined by backpropagating gradients of the objective function through the layers of the neural network and then used to update the current parameters 124 of the VLM 102 to obtain updated parameters 126 for use in a subsequent iteration of the training. The training engine 120 may, for example, use a conventional optimizer, e.g., a stochastic gradient descent, RMSprop, or Adam optimizer.

For simplicity, FIG. 1 shows a single predicted location 118 being generated by the VLM 102, but the VLM 102 can, for example, generate a plurality of predicted locations 118, e.g., a respective predicted location 118 for each of a plurality of image elements in the graphical image 104. Thus, each training data item 110 may comprise a corresponding plurality of target locations 116, and the natural language query 114 can be for identifying a plurality of image elements. As one example, the natural language query 114 may comprise “output locations for each of the data points in the scatter plot”. As one example, the VLM can generate a plurality of predicted locations for the image element, e.g., such that each predicted location corresponds to a different respective hypothesis for the location of the image element, e.g., using a top-k sampling algorithm, e.g., in which a respective probability is determined for each of the predicted locations being the correct hypothesis and a top-k (e.g., top-3,-5,-10, etc.) of the predicted locations are selected according to the probabilities. For example, in some cases, the VLM can be trained using a loss in which respective losses of a top-k predicted locations are obtained and then combined with a respective weighting determined from probability that the predicted location for the image element is correct.

FIG. 2 shows an example training data generator 112 that processes a set of instructions 202 to generate a corresponding training data item 110 comprising an image 104, target location 116 and natural language query 114. The instructions 202 are processed by a plotting library 204 to generate a corresponding image data structure 206 that is passed to a rendering engine 208, which may be part of or separate from the plotting library 204, to render the image 104. The image data structure 206 is also processed by an image element selector 210 that selects one or more image elements 212 within the image 104, e.g., by randomly selecting an image element 212 from the image elements of the image data structure 206. The training data generator 112 further comprises a location extractor 214 that determines the target location 116 of the image element 212 using the image data structure 206 and the selected image element(s) 212. The training data generator 112 further comprises a query generator 216 that processes the image data structure 206 and the selected image element(s) 212 to determine the natural language query 114.

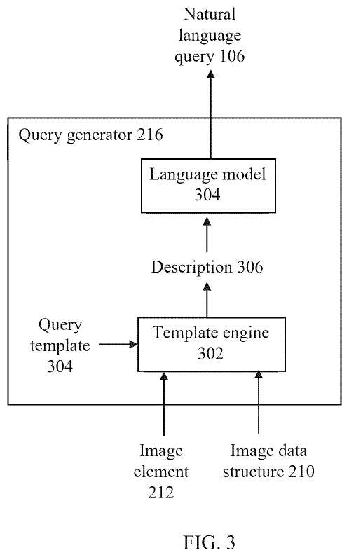

FIG. 3 shows an example query generator 216 that comprises a template engine 302 and a language model 304. The template engine 302 is configured to receive the image element 212 and the image data structure 210 as input together with a query template 304 to generate a corresponding description 306 of the image element 212 as it will appear in the image 104. For example, the query template 304 can comprise one or more placeholder elements that are replaced by corresponding properties of the image element 212. The query template 304 may additionally comprise natural language instructions for generating the natural language query 106. The language model 304, e.g., the VLM 102, processes the description 306 to generate the natural language query 106. For example, the language model 304 can be a large language model (LLM) neural network, e.g., one that has greater than 1 billion, 10 billion or 100 billion trained parameters. The language model neural network may have been trained on greater than 10 billion, 100 billion or 1000 billion words or tokens representing words or other text tokens, e.g., sub-words (also known as “word pieces”). In some cases, the VLM 102 may be configured to generate queries according to a predetermined format, syntax or schema, e.g., by performing constrained decoding. One example of constraining the output of the VLM 102 in this way is described in Koo et al., “Automata-based constraints for language model decoding” arXiv:2407.08103 (2024).

In some implementations, the language model 304 can be omitted. As one example, the query template can then comprise natural language instructions for generating the natural language query, e.g., “In the bar chart, locate the bar that is <%=bar.identifier%>”, where <%bar.identifier%> is a placeholder for a string that allows one of the bars of the bar chart to be identified, e.g., “smallest”, “largest”, “red”, “shaded”, “labelled CO₂ emissions for 2011” etc.

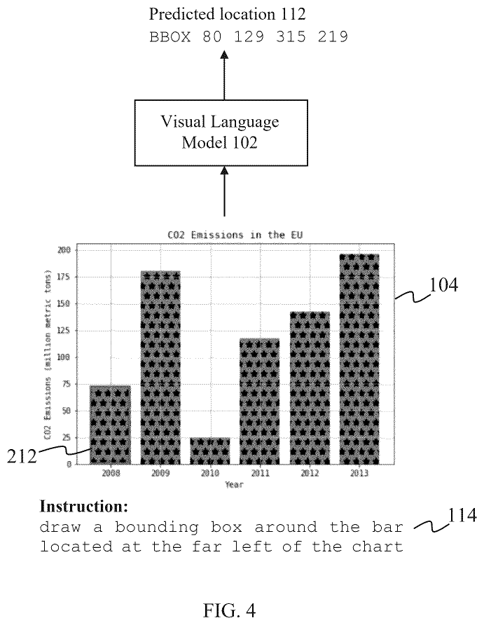

FIG. 4 shows an example graphical image 104, in this case a bar chart, and natural language query 114 (referred to here as an “instruction”), which comprises the text “draw a bounding box around the bar located at the far left of the chart”. Thus, the image element 212 in this case is the leftmost bar of the bar chart. The VLM processes the image 104 and the natural language query 114 to generate predicted location 112, which in this case is a string comprising “BBOX 80 129 315 219”, denoting a rectangular bounding box (BBOX) having, in pixel coordinates horizontal (x) limits 80 and 219 and vertical (y) limits 315 and 219.

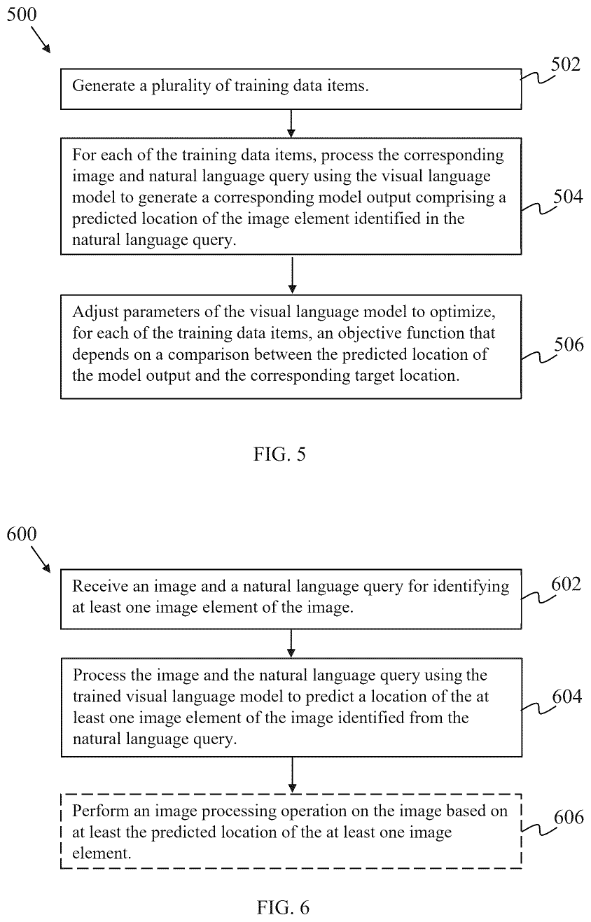

FIG. 5 is a flow diagram of an example process 500 for training a visual language model (VLM), such as the VLM 102 described above in connection with FIG. 1, to identify locations of image elements within an image. For convenience, the process 500 will be described as being performed by a system of one or more computers located in one or more locations. For example, a training system, e.g., the training system 100 of FIG. 1, appropriately programmed in accordance with this specification, can perform the process 500.

The system generates a plurality of training data items (step 502). Each training data item includes (i) an image rendered according to a corresponding set of instructions, (ii) a natural language query identifying at least one image element of the image, and (iii) a target location for the at least one image element, the target location being determined from the set of instructions.

The system then, for each of the training data items, process the corresponding image and natural language query using the VLM to generate a corresponding model output comprising a predicted location of the image element identified in the natural language query (step 504).

The system then adjusts parameters of the VLM to optimize, for each of the training data items, an objective function that depends on a comparison between the predicted location of the model output and the corresponding target location (step 506).

FIG. 6 is a flow diagram of an example process 600 for using a visual language model, such as the VLM 102 described above in connection with FIG. 1, e.g., trained using the process 600 of FIG. 5, to identify locations of image elements within an image, e.g., a graphical image. For convenience, the process 600 will be described as being performed by a system of one or more computers located in one or more locations. The system receives an image and a natural language query for identifying at least one image element of the image (step 602).

The system then processes the image and the natural language query using the visual language model to predict a location of the at least one image element of the image identified from the natural language query (step 604).

The system can then (optionally) perform an image processing operation on the image based on at least the predicted location of the at least one image element (step 606).

The trained VLM 102 can, for example, be deployed in an environment that enables users to provide requests for the VLM 102 to process specified model inputs comprising one or more images and/or text to generate corresponding model outputs. Users can provide the requests, e.g., by way of a user interface or through an application programming interface (API). The requests can be transmitted from a user device (e.g., over a data communication network, e.g., the internet) to one or more computers implementing the VLM 102, e.g., in a data center. The VLM 102 can process the model inputs specified by user requests to generate corresponding model outputs, and then transmit the model outputs to user devices (e.g., over a data communication network).

In general, the VLM 102 can be trained to perform one or more other machine learning tasks, i.e., one or more tasks in addition to the task of predicting locations of image elements identified from the natural language queries. This training can occur before or after the training described above, e.g., in connection with FIG. 5. After the VLM 102 has been trained, it can then be deployed for use in performing the one or more other machine learning tasks.

In some implementations, after training, a particular task that is to be performed by the VLM can be described by part or all of a sequence of text in the model input to the VLM 102. For example, in an input that includes an image or video item such a prompt might specify “Generate a caption”, “Generate a description”, or “Answer the following question: [about the image, or video item]”. Also or instead, such a prompt may give one or more examples of a task to be performed. A VLM 102 can be trained on multiple natural and/or computer languages and the prompt may then specify a language to use.

A few examples of some other machine learning tasks that can be performed by a VLM trained as described herein follow.

As one example, the task may comprise an object detection task. A task-specific training data item may comprise an image or video item containing one or more objects, and optionally, a sequence of text. The sequence of text may describe or otherwise identify the object(s) to be classified. The VLM can provide a model output that includes text giving bounding box coordinates for the object(s). After training, when the VLM 102 is used in inference, the model output may comprise or represent text that describes or otherwise labels detected object(s), and may include bounding-box coordinates for the detected object(s), e.g., in a case where the image is a map, “10 20 90 100 river 20 30 100 100 car park”. Alternatively, or additionally, the model output can comprise a modified version of the image annotated to identify the detected objects.

As another example, the task may comprise a classification task, e.g., an object classification task. A task-specific training data item may comprise an image or video item containing one or more objects and text classifying the object(s) in the image. The model output (e.g., text output) may describe or otherwise classify the object(s) into one of a plurality of classes. After training, when the VLM 102 is used in inference, the model output may comprise data, e.g., text, that classifies the object(s) into one of the plurality of classes.

As another example, the task may comprise an image or video item describing task, e.g., a captioning task. A task-specific training data item may then comprise an image or video item and a sequence of text describing the image or video item. After training, when the VLM 102 is used in inference, the model output may comprise data, e.g., text, describing an image or audio item. For example, the model output may provide a caption or description for the image or video item, or it may count objects in the image or video item, or it may provide some other form of description of the image or video item.

As another example, the task may comprise an image or video question-answering task. A task-specific training data item may then comprise an image or video item and a sequence of text that describes the image or video item. After training, when the VLM 102 is used in inference, the model output may comprise data, e.g., text, that answers a question about the image or video specified in a prompt sequence of text. This may be used, e.g., to answer questions about a graphical image, e.g., visual plots and charts. As one example, the trained VLM 102 can be used to process an image, captured by a camera, that comprises a graphical image, e.g., a photograph or video frame comprising a graphical image, e.g., on a display surface, such as a whiteboard, blackboard, or paper document. For example, the VLM 102 may be used to process graphical images drawn or sketched on a whiteboard or paper, e.g., during a design or planning meeting, to perform any of a number of tasks, such as summarising, answering questions, or otherwise providing feedback regarding the drawn or sketched graphical image.

As another example, the task may comprise a character or word recognition task, e.g., an OCR (optical character recognition) task. A task-specific training data item may then comprise an image or video item and a sequence of text that includes text that is depicted in the image or video. After training, when the VLM 102 is used in inference, the model output may comprise text that represents characters or words, e.g., in a natural language. The one or more “characters” may, for example, comprise alphanumeric characters, logograms (e.g., Chinese characters and/or characters from other logographic writing systems), symbols, syllabograms, ideograms, ideographs, pictographs, graphemes, graphical symbols or objects, and the like. For example, the VLM 102 can recognise image elements of a graphical image and generate a model output that describes the graphical image as a sequence of graphical objects.

As another example, the task may comprise a still or moving image generation task. A task-specific training data item may comprise an image or video item and a sequence of text that describes the image or video item. After training, when the VLM 102 is used in inference, the model output may comprise data for an image or video item, e.g., image data defining values for pixels of a still or moving image, and the sequence of text in the multimodal input to the model may describe or characterize the image or video item to be generated. For example, the VLM 102 can generate or modify a graphical image comprising one or more image elements, e.g., to construct a diagram or chart.

As another example, the task may comprise a computer language text generation task. A task-specific training data item may comprise an image or video item and a sequence of text in a computer language for generating the image or video item. After training, when the VLM 102 is used in inference, the model output may comprise text in the or another computer language for generating or rendering an image or audio item in the second modality input, e.g., a web page, plot, or chart.

In another example of a computer language text generation task, a task-specific training data item may comprise an image or video item and a sequence of text in a computer language for performing a task in relation to the image or video item, e.g., a data processing task that involves analyzing the content of the image or video item to provide a result of the analysis or, e.g., a search to search for information relating to the content of the image or video item. The computer language in the model output may comprise computer language for invoking a function or calling one or more external APIs. Merely as one example, such an output may be formatted as a JSON object. As previously, the sequence of text in the model input may define the task to be performed and may comprise, e.g., an image or video item in relation to which the task is to be performed, e.g., a task that involves manipulation of particular types of data that may benefit from access to an API such as mathematical data, date/time related data, scientific data, recent data that may post-date training of the model (that may be accessed by a search function or API), and so forth. After training, when the VLM 102 is used in inference, the model output may comprise text in the or another computer language for performing a task, e.g., as described above, in relation to an image, video, or audio item in the second modality input. The method may then include using the text in the computer language to perform the task.

In general, where the model output comprises text this may be provided as speech representing the text.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what can be claimed, but rather as descriptions of features that can be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features can be described above as acting in certain combinations and even initially be claimed as such, one or more features from a claimed combination can in some cases be excised from the combination, and the claimed combination can be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing can be advantageous.

What is claimed is:

1. A method performed by one or more computers and for training a visual language model to identify locations of image elements within a graphical image, the method comprising:
generating a plurality of training data items, each training data item including (i) a graphical image rendered according to a corresponding set of instructions, (ii) a natural language query for identifying at least one image element of the graphical image, and (iii) a target location for the at least one image element, the target location being determined from the set of instructions;
for each of the training data items, processing the corresponding graphical image and natural language query using a visual language model to generate a corresponding model output comprising a predicted location of an image element identified from the natural language query; and
adjusting parameters of the visual language model to optimize, for each of the training data items, an objective function that depends on a comparison between the predicted location of the model output corresponding to the training data item and the target location of the training data item.

2. The method of claim 1, wherein generating the plurality of training data items comprises, for each of the training data items:
processing the set of instructions corresponding to the graphical image of the training data item to generate a data structure comprising one or more pairs of coordinates for the at least one image element of the training data item; and
determining the target location of the at least one image element using the data structure.

3. The method of claim 1, wherein determining the target location of the at least one image element using the data structure comprises converting the one or more pairs of coordinates to corresponding pixel locations within the graphical image.

4. The method of claim 2, wherein the natural language query includes a natural language description of the at least one image element, the description being generated using (i) the set of instructions corresponding to the graphical image, or (ii) the data structure, or (iii) both.

5. The method of claim 4, wherein generating the natural language description of the at least one image element comprises updating a query template by replacing one or more placeholder elements of the query template with corresponding properties of the at least one image element, the query template comprising natural language instructions for generating the natural language query.

6. The method of claim 5, wherein the one or more properties of the at least one image element comprise one or more of: a name of the image element; a type of the image element; a label in the image corresponding to the image element; a shape of the image element; a style, color or texture of the image element; an orientation of the image element; and text associated with the image element.

7. The method of claim 5, wherein the natural language query is generated by processing the updated query template using a language model.

8. The method of claim 1, wherein each set of instructions is generated by sampling one or more values of a corresponding image property from a distribution of values for the image property.

9. The method of claim 8, wherein the one or more image properties comprise one or more of: an arrangement of image elements in the graphical image; a color or style for the graphical image or for an image element of the graphical image; a size of the graphical image or of an image element of the graphical image; text to display in the graphical image; text to label an image element of the graphical image; values for quantities represented in a chart of the graphical image.

10. The method of claim 1, wherein each predicted location comprises locations of vertices of a polygon that encloses all or part of the corresponding image element.

11. The method of claim 1, wherein each predicted location comprises one or more pixel locations within the image for the corresponding image element.

12. The method of claim 1, wherein each graphical image comprises text.

13. The method of claim 1, wherein each graphical image comprises a respective one or more of: a diagram, a chart, a data table and a map.

14. The method of claim 1, further comprising, after training the visual language model:
receiving an image and a natural language query for identifying at least one image element of the image; and
processing the image and the natural language query using the visual language model to predict a location of at least one image element of the image identified from the natural language query.

15. The method of claim 1, further comprising, after training the visual language model, using the visual language model to perform a character or word recognition task on an image.

16. The method of claim 14, further comprising annotating the image at a location derived from the predicted location of the at least one image element.

17. The method of claim 14, further comprising generating data associating the predicted location of the at least one image element with a corresponding substring of the natural language query or a text output of the visual language model.

18. The method of claim 14, further comprising performing an image processing operation on the image based on at least the predicted location of the at least one image element.

19. A system comprising one or more computers and one or more storage devices storing instructions that when executed by the one or more computers cause the one more computers to perform operations for training a visual language model to identify locations of image elements within a graphical image, the operations comprising:
generating a plurality of training data items, each training data item including (i) a graphical image rendered according to a corresponding set of instructions, (ii) a natural language query for identifying at least one image element of the graphical image, and (iii) a target location for the at least one image element, the target location being determined from the set of instructions;
for each of the training data items, processing the corresponding graphical image and natural language query using a visual language model to generate a corresponding model output comprising a predicted location of an image element identified from the natural language query; and
adjusting parameters of the visual language model to optimize, for each of the training data items, an objective function that depends on a comparison between the predicted location of the model output corresponding to the training data item and the target location of the training data item.

20. One or more computer storage media storing instructions that when executed by one or more computers cause the one more computers to perform operations for training a visual language model to identify locations of image elements within a graphical image, the operations comprising:
generating a plurality of training data items, each training data item including (i) a graphical image rendered according to a corresponding set of instructions, (ii) a natural language query for identifying at least one image element of the graphical image, and (iii) a target location for the at least one image element, the target location being determined from the set of instructions;
for each of the training data items, processing the corresponding graphical image and natural language query using a visual language model to generate a corresponding model output comprising a predicted location of an image element identified from the natural language query; and
adjusting parameters of the visual language model to optimize, for each of the training data items, an objective function that depends on a comparison between the predicted location of the model output corresponding to the training data item and the target location of the training data item.
